(19) United States
(12) Patent Application Publication
(10) Pub. No.: US 2010/0314878 A1
(43) Pub. Date: Dec. 16, 2010

(54) Direct Generation of Steam Motive Flow by Water-Cooled Hydrogen/Oxygen Combustion

(76) Inventor: Monte Douglas DeWitt, Austin, TX (US)

Correspondence Address: Monte Douglas DeWitt, 8400 El Rey Boulevard, Austin, TX, 78737-1321, US

(21) Appl. No.: 12/485,894

(22) Filed: Jun. 16, 2009

(51) Int. Cl. H02K 7/18; F02C 3/30; F02C 3/20; F03D 9/02

(52) U.S. Cl. 290/52; 60/775; 60/39.461; 290/55

(57) ABSTRACT

A hydrogen/oxygen combustion system of direct steam generation of motive flow, with the capacity to regulate and control temperature and pressure conditions, enabling the use of spontaneously generated motive flow in turbine-driven power generating system applications. Steam is generated directly by the combustion reaction between hydrogen and oxygen gas fuel stocks, temperature-regulated by the injection of water into the body of super-heated steam generated by such a reaction. Motive body temperature is controlled by the absorption of heat inherent in the vaporization of water-injectate; regulation of temperature is a function of the ratio of water to feed-stock gas, injected into the motive body. Motive body pressure is regulated by controlling the total flow of gas fuel stocks and water into the combustion chamber of the steam-generating engine. Exhaust steam is compressed and ported to the next engine, or from a final stage to the condenser for recovery.

### COPYRIGHT NOTICE AUTHORIZATION

A portion of the disclosure of this patent document contains material which is subject to copyright protection, there appearing notice herein consistent with the provisions of 17 U.S.C. 401. The copyright owner, herein the First Named Inventor, has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to the direct generation of steam as motive flow to drive a turbine-driven, internal combustion, and/or other class of mechanical engine or device. It is useful in applications ranging from driving a turbine-driven electric power generating system, a turbine-driven mechanical drive-train, a piston-driven mechanical drive-train, and/or a turbine-driven reactive or turbojet-type propulsion system. The invention relates more particularly to a system using direct generation of steam motive flow by water-cooled combustion of hydrogen and oxygen gas feed-stocks, as well as using hydrogen and oxygen gas feed-stocks mixed with water to control the heat of combustion in an internal combustion engine environment. In the preferred embodiment, high-pressure hydrogen and high-pressure oxygen are the primary combustion fuels, generating high-energy stream of super-heated steam, into which water is directly injected to absorb heat in the process of vaporization, conditioning the motive flow body in a way that positively contributes to its volume and force.

From a theoretical perspective, using a stoichiometric fuel mixture that yields maximum heat energy release, and then effectively converting virtually all generated exothermic energy into superheated steam energy, highest-possible fuel-to-steam energy efficiencies should be attainable. In fact, integration of the design components inherent to the invention has produced a system capable of generating electricity using conventional steam-turbine technology with the added benefits of zero-wait-state black-start capability, and the potential for zero-level carbon footprint if feed-stocks are generated from surplus energy production as part of a renewable-energy co-generation strategy.

### DESCRIPTION OF THE PRIOR ART

The generation of power via steam production driving the turbine blades of an electric generator in a power plant application is by far the most common method of producing electric power in the United States, as well as the rest of the world. With the relatively sudden awakening of the people of earth to the realities of global warming, and with the major blame for such impending catastrophic events as may result from that global warming being attributed to the burning of carbonaceous fuels, and to the generation of greenhouse gases that are inadvertently produced in the process, critical importance has been attached to the search for practical alternatives to the burning of coal and other fossil fuels in the generation of base-load electricity for public consumption.

Alternative sources of energy production, specifically wind and solar generation technologies, can be deployed in quantities sufficient to replace fossil-fuel fired generation during daylight hours and when the wind blows. However, co-generation must be employed to compensate for the inherently intermittent generational output of wind or solar renewable energy technologies, in order to condition, or “level” the load generated by both. Historically this task has been accomplished with those fossil-fuels that renewable energy technologies seek to replace, thereby inherently creating an unacceptable carbon footprint of its own as conventional co-generation facilities must maintain a constant ready-state of steam, requiring that the fires keep burning even when the wind is blowing or the sun is shining for days at a time. The waste of carbonaceous fuels is staggering.

Fortunately, steam-driven turbines operatively associated with generators to create large-scale electricity production have a very long and impressive track-record; there is no need to reinvent such technology.

There was some early work by researchers involved with the space program several years ago in developing a rudimentary system for generating a motive body directly by vaporizing pre-heated water using hydrogen and oxygen as a fuel source, in order to operate a gas turbine.

Hydrogen contains more energy potential in an oxidation reaction than any other known element. When combined with pure oxygen in stoichiometric proportion, as in the formula:

2H.sub.2+O.sub.2→2H.sub.2O

the water that is formed by the combustion reaction appears in the form of steam at temperatures exceeding 5,000° F.; at such temperatures the blades of a conventional steam turbine would not survive. Under pressures typical of modern turbine technology, stoichiometric hydrogen/oxygen combustion generates in excess of 6,000° F., making it the highest-energy oxidation/combustion reaction known to physical chemistry.

The concept of driving a conventional turbine with these products of combustion historically has been regarded as inefficient at best, and subsequently dismissed as an impractical approach. The heat of combustion of the reaction has always been seen as an undesirable by-product requiring physical dissipation in order to prevent the relatively fragile blades of commercial turbines from melting. Attempts to cool the steam body before entering a turbine inlet for the most part consisted of passing pipes through heat exchangers, imparting the excess heat to circulating water. Ultimately the result was a steam-body cool enough to pass through a turbine, but the amount of energy lost to the cooling process resulted in unacceptably low efficiencies, and the approach was never considered commercially viable.

There appears to have been little subsequent interest from those researchers within the steam turbine and power generation industries, as coal was plentiful and cheap in a time when greenhouse gases were the stuff of a radical fringe of doom-and-gloom proponents, and in a time when the concept of “carbon footprint” did not yet exist.

The work of Edward V. Somers, an engineer for Westinghouse Electric Corporation, was based on original design concepts proposed by Escher Technology Associates in a study done for Rocketdyne, a division of North American Rockwell, and was the basis for a 1979 patent given to a rudimentary version of the process described below, in which a pre-heated water stream substrate was heated to a conditioned-steam state using hydrogen and oxygen combustion in a closed chamber. Pressure was presumably regulated by regulating the flow of heated water into the chamber. Although there was no feedback or control associated with the system, it did acknowledge that the water-steam substrate flow entering the combustion chamber would absorb significant heat when hydrogen and oxygen were ignited in a manner similar to work being done in rocket engine research at Rocketdyne's location in southern California at the time.

Somers' invention specified the use of a gas turbine, which would normally burn natural gas and air to drive the turbine, rather than steam generated by any source; the high-humidity environment characteristic of a body of steam as motive flow, would not normally be compatible with gas turbine systems. Intermediate-pressure and low-pressure turbine stages were envisioned along with re-heating provisions, although water supplies to the combustion chambers generating motive fluid for them were not included in the Somers patent. The process was never adopted commercially, and the patent granted it has subsequently expired.

With the rise in the development of renewable energy technologies and the subsequent deployment of those technologies throughout the world, the need for co-generation of intermittent load power production came into being. Conventional fossil fuel generation was the only available source for this co-generation, the waste and environmental liabilities of this source of co-generated power considered acceptable liabilities inherent to the process. Only recently has fossil-fuel co-generation been recognized as a significant contributor to global warming and the proliferation of greenhouse gases. The present invention in the preferred embodiment represents the first availability of local storage of intermittent renewable energy generation, and subsequent retrieval using readily-available existing technology, resulting in pre-conditioned, 100% renewable balanced load capable of being used by commercial utilities without co-generation on their part.

Hydrogen and oxygen can be produced on a commercial scale using readily-available existing technology from electric power generated from a variety of renewable sources. Using an algorithm in which a wind-generated load can be analyzed and divided between above-median output and below-median output, the former being diverted into hydrogen production and storage while the latter is loaded onto the grid for consumption, co-generation can be accomplished with a zero-level carbon-emissions footprint. Perhaps most importantly, the present invention in one embodiment provides that co-generation capacity utilizing a zero-wait-state system, capable of bringing a turbine up to full operating capacity with immediately-available and optimally-conditioned steam motive flow.

### SUMMARY OF THE PRESENT INVENTION

The present invention is generally related to the early work of Escher and his associates, and of Somers at Westinghouse, in that it provides in one embodiment a turbine-driven power generation plant, using steam as the motive fluid necessary to produce electric power output. In subsequent embodiments the present invention is only tangentially-related to the prior art.

The present invention also uses a fuel mixture of hydrogen and oxygen, “with the combustion process cooled by the introduction of water or steam” as Mr. Somers states in his patent summary. However, in this invention, the generation of steam at the first stage combustion chamber does not rely on the preheating of water prior to cooling the products of primary fuel combustion. The system relies on the combustion of hydrogen and oxygen for the primary motive fluid source, the sole product of that combustion being superheated steam, the heat of which is absorbed by the process of vaporizing a supplemental injection of water into the motive body of superheated steam, thereby conditioning the motive body by reducing its temperature to one optimum for the specific application for which the motive body is generated. In contrast, the prior art relied on a pressurized, pre-heated water substrate flow as the primary source of steam production, using a hydrogen/oxygen gas flow of unspecified quantity, with an unspecified control or regulatory mechanism, and then subsequent combustion of that gas-mixture to heat the water-flow substrate to sufficient levels to operate a gas turbine.

In the present invention, the combustion of hydrogen and oxygen within the combustion chamber creates a motive fluid body of supercritical, or superheated steam in a temperature range approaching 6,000° F., far in excess of the melting point of the most durable turbine-blade component materials. The system is designed to accept a high-pressure injection of water into the body of the superheated motive body stream downstream of the point of combustion, instantly vaporizing the water and absorbing heat in proportion to the volume of water and the latent heat of vaporization, and adding substantive contributory volume to the total motive fluid body in the process.

Regulatory control of water-flow and gaseous feed-stock flow is provided by a computerized central control system, based on data transmitted to it by a thermocouple sensor array subsystem that transmits temperature information to said central control system, and by a pressure-transducer sensor array subsystem that transmits pressure information to said central control system. Each sensor array subsystem is located in the immediate proximity of the steam intake port of the specific application, connected in motive flow communication with the steam-generating engine.

The computerized central control system regulates individual hydrogen and oxygen gas flow-rates, water injectate flow-rate, and overall system efficiency of one or a plurality of steam-generating engine systems, producing optimally-conditioned steam motive bodies in the preferred embodiment, by actuating servo-driven automated flow-regulating valves for each of the three fluid components deployed in the system.

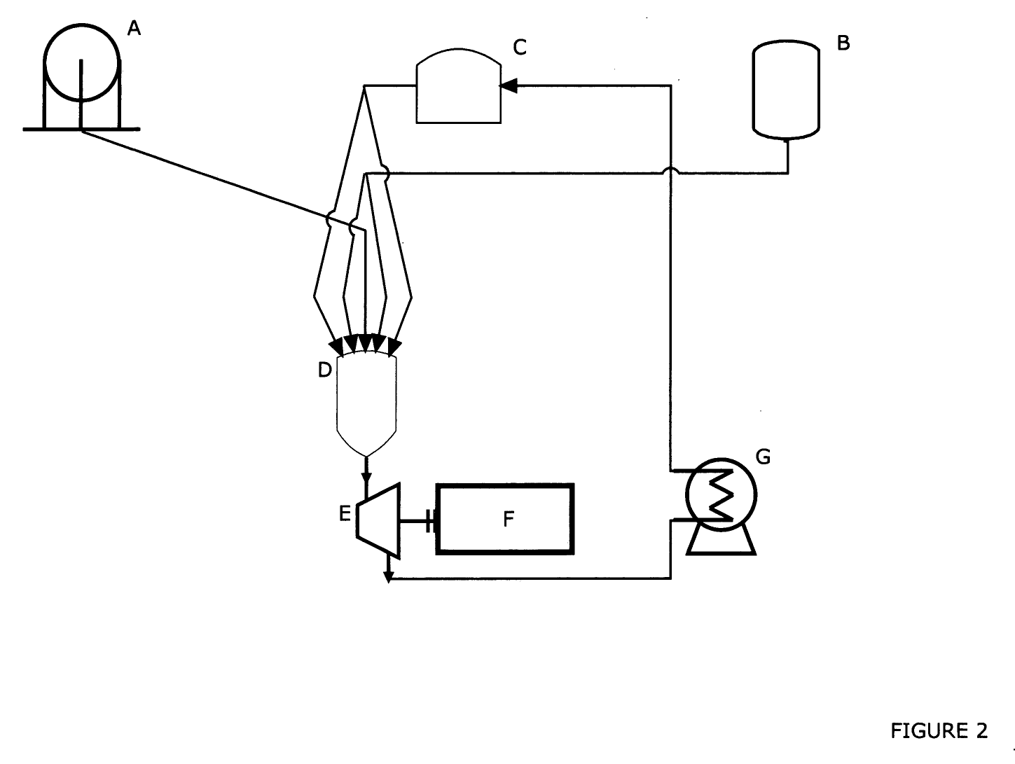

In one embodiment as represented in FIGS. 2 through 4, the system is used for driving commercially-available single- or multi-stage steam turbine power plants.

Power is thus produced with virtually no startup delay, as steam is generated on demand. Deployment of the invention in a co-generation strategy in which surplus renewable energy production is converted to hydrogen and oxygen feed-stocks for storage, and subsequently used to generate steam using the present invention to drive a conventional steam turbine-generator system, and thereby regenerating electricity on demand marks the first system for immediately-available, on-demand retrieval of stored energy derived 100% from a renewable energy generation source to reach the utility industry and the consumer marketplace.

In another embodiment not represented by a Drawing, the system is used for driving a steam-turbine to generate rotational force imparted to a flywheel or driveshaft by way of a clutch-control mechanism, for further impartation to motive or other power applications.

In another embodiment not represented by a Drawing, the system is used for driving a piston-type mechanical steam engine of the type that arguably started the industrial revolution, as exemplified by, though not limited to, the steam locomotive or myriad rotating-wheel engines of the last two-hundred or more years.

In another embodiment not represented by a Drawing, the system is used for driving a steam-turbine to generate turbojet-type Newtonian reactive forces imparted to a motive vector for a variety of uses including but not limited to aviation or extra-atmospheric, and/or land and/or rail vehicular applications.

The system in the preferred embodiment, when deployed in an electric power generation application using steam-driven turbines, is closed with respect to net water consumption by the system; the system generates primary fuel by consuming electricity and water, and then the system returns virtually all the water, condensing exhaust steam at the completion of the power cycle to return that water via the condensate pump system to its place of origin within the system.

In other embodiments in which exhaust must necessarily discharge into the atmosphere because of the inherent design of the application, water will neither be consumed nor destroyed, consistent with principles of Conservation of Matter. Discharged vapor will simply enter the normal cycle of atmospheric and meteorological events and systems within which water is continuously recycled by nature.

In another embodiment not represented by a Drawing, the system is used for driving a mobile-type railroad locomotive electricity generator, for the purpose of creating motive force to the locomotive, thereby moving a train of railroad cars. The railroad industry potential of the invention is dramatic, as by its very nature a locomotive is inherently capable of pulling large bulk stores of water and fuel feed-stocks over long geographic distances, enabling it to travel from coast-to-coast without refueling.

### BRIEF DESCRIPTION OF THE DRAWINGS

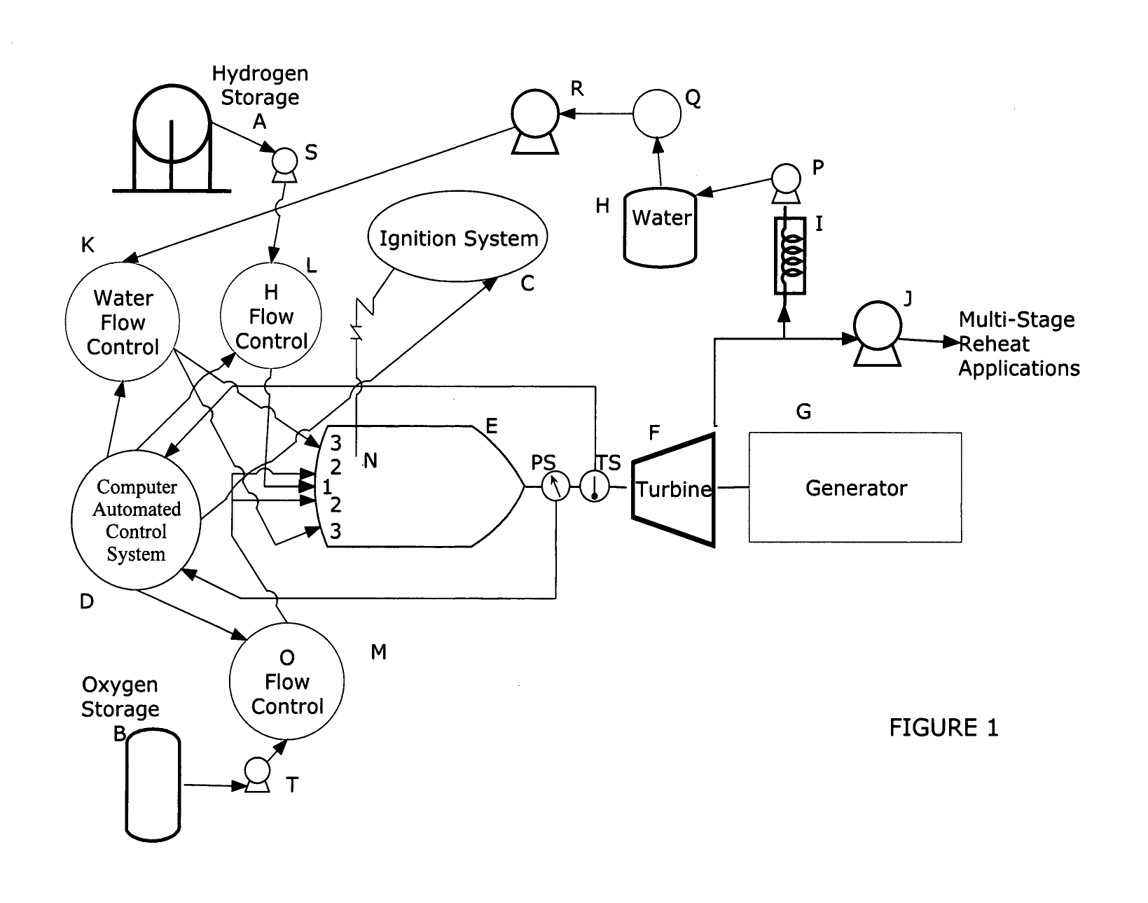

The FIG. 1 is a schematic illustration of the preferred embodiment, a steam-generating system complete with control, water, hydrogen and oxygen subsystems according to Claims 1, 2, and 3, and depicting the deployment of motive flow to a steam-powered turbine-driven electricity generator system of conventional design, solely for the purpose of more clearly describing, and therefore further illustrating, the functional design concepts inherent to the water-injectate subsystem, and the temperature and pressure data feedback systems, they being integral to the preferred embodiment; it should be clearly understood that the preferred embodiment allows, but is not limited to, deployment in a turbine-driven generator application. The FIG. 2 is a schematic illustration of the preferred embodiment steam-generating engine system deployed in a single-stage steam turbine-driven power generating plant configuration of modern design.

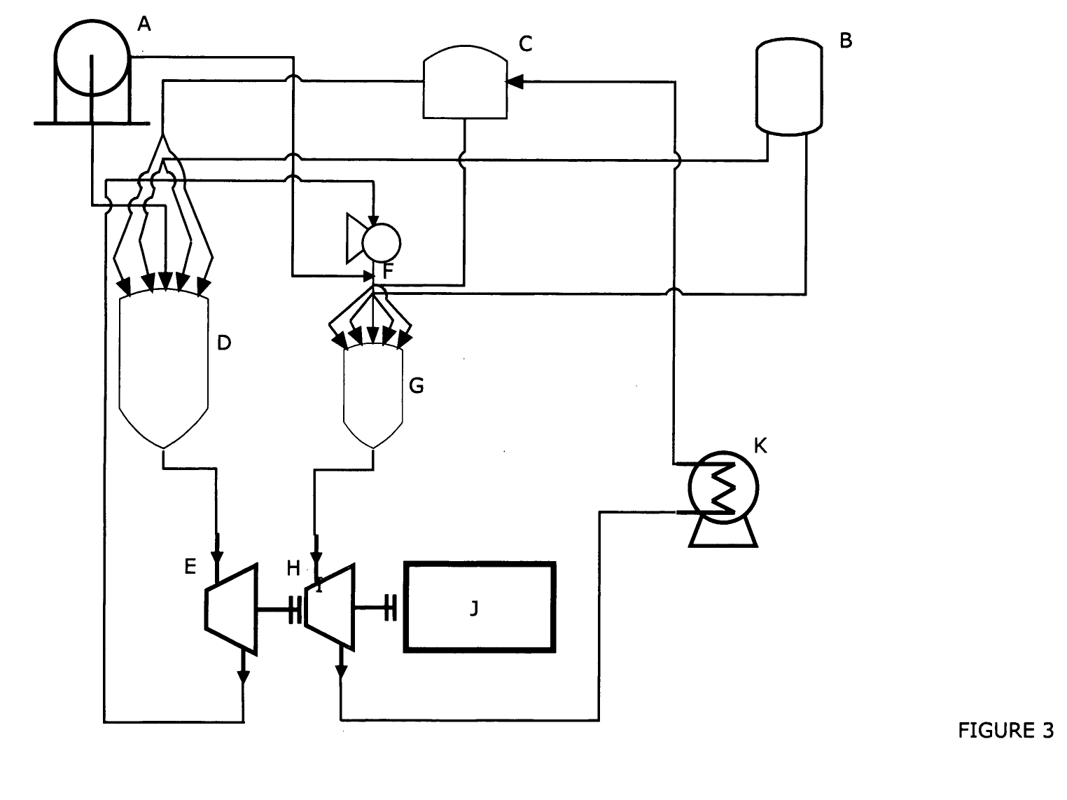

The FIG. 3 is a schematic illustration of two (2) steam-generating engines deployed in a two-stage steam turbine-driven power generating plant configuration of modern design.

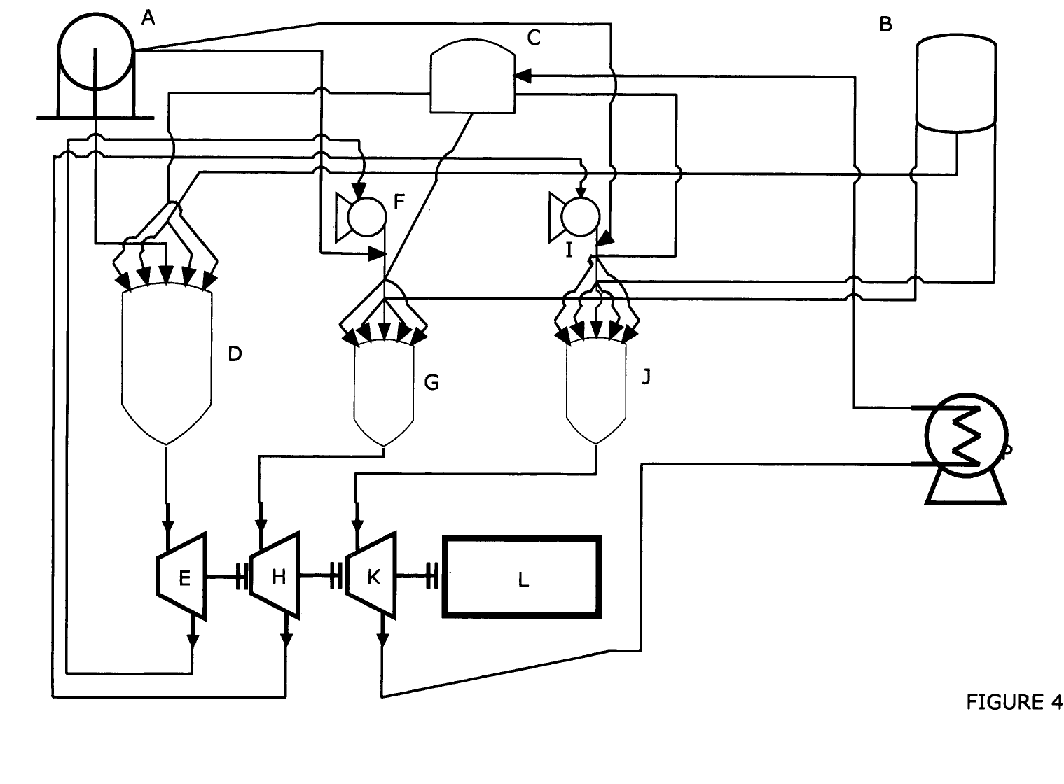

The FIG. 4 is a schematic illustration of three (3) steam-generating engines deployed in a three-stage steam power generating plant configuration of modern design.

### DESCRIPTION OF THE PREFERRED EMBODIMENT

Referring to FIG. 1, a steam-generating engine system is shown having: a hydrogen gas storage system A, supplying pressurized primary hydrogen gas fuel under pressure imparted to the hydrogen gas supply by hydrogen gas feed pump S, such that hydrogen gas fuel stock is supplied under pressure greater than that pressure found within the combustion chamber and the communicating application inlet, said hydrogen gas feed pump S thereby supplying hydrogen gas to a primary hydrogen gas supply valve, which in the preferred embodiment is represented by automated servo-controlled valving comprising the hydrogen flow-control subsystem L, through which the hydrogen gas supply must flow en route to the combustion chamber E; and,

an oxygen gas storage system B, supplying pressurized primary-fuel-oxidizer oxygen gas under pressure imparted to the oxygen gas supply by oxygen gas feed pump T, such that oxygen gas fuel (oxidizer) stock is supplied under pressure greater than that pressure found within the combustion chamber and the communicating application inlet, said oxygen gas feed pump T thereby supplying oxygen gas to a primary oxygen gas supply valve, which in the preferred embodiment is represented by automated servo-controlled valving comprising the oxygen flow-control subsystem M, through which the oxygen gas supply must flow en route to the combustion chamber E; and,

a water supply storage system H, supplying water to a deaerator system Q that removes corrosive gases and other components from the water supply, and thence to a boiler feed pump R to impart pressure in excess of combustion chamber pressure and corresponding turbine inlet pressure, the flow of water then regulated by automated servo-controlled valving comprising the water flow-control subsystem K through which it must flow en route to the combustion chamber E; and,

a water recovery subsystem comprised of exhaust steam extracted from turbine F, from which that exhaust steam is: (a) either ported to compressor J before being ported to the multi-stage reheat process functions of a given specific application; or alternately (b) exhaust steam is ported to a condenser unit subsystem I, from which condensate is subsequently recovered and thence is ported via condensate pump P, to the main holding reservoir of water supply system H for recirculation through the system.

Referring again to FIG. 1, gas fuel stocks are mixed via flow nozzles at locations 1 and 2, and subsequently ignited via an ignition system comprised of redundant glow-plug ignitors N, supplied with 12 VDC current supplied by an automotive battery of conventional design via switched ignition system C, which is activated upon the initiation of gas fuel stock flows by the Computer Automated Control System D, to produce a combustion of gas fuel stocks within combustion chamber E, into which water is injected via multiple fog-head nozzles located at locations 3, to provide steam motive flow body under temperature and pressure to the turbine inlet.

Referring again to FIG. 1, component flow subsystem valving control is provided by the Computer Automated Control System D, that receives system pressure data input from pressure sensor devices in array PS, and system temperature data input from temperature sensor devices in array TS, both located in the steam feed pipe immediately proximal to the steam inlet of the turbine F, which is driving the generator G.

Referring again to FIG. 1, the control algorithm provides for an increase in fuel stock gas-flow and water flow in a pre-established ratio when turbine inlet pressure falls below a pre-established optimum turbine inlet steam pressure. The control algorithm provides for a decrease in fuel stock gas-flow, and/or water flow in a pre-established ratio when turbine inlet pressure rises above a pre-established optimum turbine inlet steam pressure. The control algorithm also provides for an increase in the ratio of water injectate to fuel-mix when steam temperature at the turbine inlet exceeds the optimum turbine inlet steam temperature, and a decrease when temperature at the turbine inlet falls below optimum turbine inlet steam temperature.

Referring again to FIG. 1, water is being fed under pressure by the water flow control subsystem K, and injected directly into the motive body of steam created by the combustion of the primary fuel gases in the combustion chamber E via an array of water-dispersing fog-head nozzles that maximize water droplet surface area to facilitate vaporization by the available heat generated by the combustion of primary fuel stocks within said combustion chamber.

Referring again to FIG. 1, a supply of motive steam is generated and subsequently delivered to the appropriate steam intake port of turbine F at conditions of temperature and pressure, determined by the manufacturer to support operation at maximum output efficiency. The motive flow turns turbine F in the manner for which it was originally designed, driving generator G to turn in the manner for which it was originally designed, thereby exhibiting operating characteristics identical to its operating characteristics using traditional boiler-generated steam motive flow, and thereby generating electricity output for consumption in the traditional manner.

Referring again to FIG. 1, the Computer Automated Control System D will regulate flow control subsystems K, L, and M using feedback data provided by arrays PS and TS, and thus will stabilize the flow of each component in a ratio that will become a series of pre-determined valve-settings for the specific application in which the system has been deployed. In a fashion unique to the preferred embodiment, the system will “learn” optimum ratios that will maximize system efficiency, allowing the system to be initiated from a cold start, whereby motive flow can be delivered to the turbine on demand by opening supply subsystem valves to their pre-determined settings within eight-seconds.

### Dependent Embodiments, Illustrating Power Generation Applications

Now referring to FIG. 2, a steam-driven, single-stage turbine electric power generating system is shown having one (1) steam-generating engine D of primary-steam-condition output capacity rating, driving a single-stage generator system F by way of driving turbine E with steam motive flow. The hydrogen supply subsystem A, and the oxygen supply subsystem B, are shown supplying the combustion chamber within D with pressurized fuel and oxidizer components. The water supply subsystem C is shown supplying the combustion chamber within D with pressurized water-cooling injectate.

Referring again to FIG. 2, a steam-generating engine D ports steam as the motive fluid driving turbine E which in turn drives generator F thereby generating electric power output. Exhaust steam exiting turbine E is ported to the condenser subsystem G, within which water is recovered from the exhaust steam and returned to the water supply subsystem C for further disposition.

Now referring to FIG. 3, showing a steam-driven, two-stage turbine electric power generating system is shown having two (2) steam-generating engines D and G of different output capacity ratings, driving a two-stage turbine system represented by stages E and H, operating in tandem to drive generator J. The hydrogen supply subsystem A, and the oxygen supply subsystem B, are shown supplying both combustion chambers within steam-generating engines D and G with pressurized fuel and oxidizer components. The water supply subsystem C is shown supplying both combustion chambers within steam-generating engines D and G with pressurized water-cooling injectate.

Referring again to FIG. 3, a steam-generating engine D ports steam as the motive fluid driving the primary turbine stage E, from which exhaust steam is ported to intermediate compressor F, where exhaust steam is compressed to the intake pressure-levels required by the low-pressure turbine stage H, and then ported to the pressurized, and now partially reconditioned exhaust steam intake at the rear of the combustion chamber within steam-generating engine G. Fuel, oxidizer, and water-cooling injectate components are combined in ratios determined by the computerized control system in volumes sufficient, when added to the pressurized steam substrate entering the steam intake port of steam-generating engine G, to generate those pressure-levels and temperature-levels required at the intake port of the low-level turbine stage H as determined by the feedback data sensors located at that point.

Referring again to FIG. 3, a steam-generating engine G ports steam as the motive fluid driving the low-pressure turbine stage H, operating in tandem with the primary turbine stage E to drive generator J, thereby producing electric power output Exhaust steam is ported from the exhaust port of turbine stage H to the condenser subsystem K, within which water is recuperated from the final exhaust steam and returned to the water supply subsystem C for further disposition.

Now referring to FIG. 4, a steam-driven, three-stage turbine electric power generating system is shown having three (3) steam-generating engines D, G, and J of different output capacity ratings, driving a three-stage turbine system E, H and K operating in tandem to drive generator set L. The hydrogen supply subsystem A, and the oxygen supply subsystem B, are shown supplying all three combustion chambers within steam-generating engines D, G and J with pressurized fuel and oxidizer components. The water supply subsystem C is shown supplying the three combustion chambers within steam-generating engines D, G and J with pressurized water-cooling injectate.

Referring again to FIG. 4, a steam-generating engine D ports steam as the motive fluid driving the primary, super-critical turbine stage E, from which exhaust steam is ported to intermediate compressor F, where exhaust steam is compressed to the intake pressure-levels required by the intermediate turbine stage H, and then ported to the pressurized exhaust steam intake at the rear of the combustion chamber within steam-generating engine G. Fuel, oxidizer, and water-cooling injectate components are combined in ratios determined by the computerized control system in volumes sufficient, when added to the pressurized steam substrate entering the steam intake port of steam-generating engine G, to generate those pressure-levels and temperature-levels required at the intake port of the intermediate-pressure turbine stage H as determined by the feedback data sensors located at that point.

Referring again to FIG. 4, a steam-generating engine G ports steam as the motive fluid driving turbine stage H, from which exhaust steam is ported to intermediate compressor I, where exhaust steam is compressed to the intake pressure-levels required by the low-pressure turbine stage K, and then ported to the pressurized exhaust steam intake at the rear of the combustion chamber within steam-generating engine J. Fuel, oxidizer, and water-cooling injectate components are combined in ratios determined by the computerized control system in volumes sufficient, when added to the pressurized steam substrate entering the steam intake port of steam-generating engine J, to generate those pressure-levels and temperature-levels required at the intake port of the low-pressure turbine stage K as determined by the feedback data sensors located at that point.

Referring again to FIG. 4, a steam-generating engine J ports steam as the motive fluid driving the low-pressure turbine stage K, operating in tandem with primary turbine stage E and secondary turbine stage H to drive generator L thereby producing electric power output. Exhaust steam is ported from the exhaust port of turbine stage K to the condenser subsystem P, within which water is recuperated from the final exhaust steam and returned to the water supply subsystem C for recirculation within the system.

For purposes of analyzing the system of the present invention, it can be assumed to conform to the following conditions:
1. The direct combustion of hydrogen and oxygen gases in stoichiometric proportion within a ported combustion chamber equipped with an electronic ignition subsystem will create a motive body of superheated, super-critical steam.
2. Heat energy will be absorbed from the motive steam-body as the latent heat of vaporization of water is extracted from the reaction in the process of vaporizing the water-injectate fog-stream.
3. Water will be injected into the motive-flow body in sufficient volume to reduce the temperature of the body to a level consistent with optimal motive flow conditions for a specific application.
4. As water is vaporized it will substantively add to the total volume of the body of motive steam generated by the system.
5. The computerized automatic control system will regulate the flows of each component subsystem to achieve perfect temperature and pressure for each individual application, based on temperature and pressure feedback data supplied by sensor array components of the control subsystem.
6. Supercritical or subcritical steam, as dictated by the specific temperature and pressure requirements of any given application will dictate the operating parameters of each steam-generating engine deployed in that application.
7. Supercritical primary steam motive flow conditions at the turbine inlet average near 2,000 psig (pounds per square inch, gauge measured) and approximately 1,050° Fahrenheit.
8. At supercritical conditions, water cannot remain in the liquid state; a motive flow body deployed in an application, even one characterized by very short distances between combustion chamber and deployment intake port, will manifest and present as fully-conditioned steam-load, devoid of either water or impurities.
9. The system will require approximately eight-seconds startup time, equal to the time required to cycle the largest regulating flow valving subsystem through its entire range, thereby creating optimum steam conditions at the application intake virtually on demand.
10. The deployment of the invention in a co-generation strategy marks a significant and dramatic advance in renewable energy storage and on-demand retrieval.

I claim:

1. A steam-generating engine having a combustion chamber constructed consistent with AMSE B31.1 Code standards, wherein a pressurized flow of hydrogen gas, or H.sub.2, and oxygen gas, or O.sub.2, is ignited via an ignition source within said combustion chamber creating a high-temperature, high-pressure stream of super-heated steam comprising the substrate basis for a motive flow body, into which a pressurized supply of water, or H.sub.2.O, is injected by way of dispersing nozzles into the body of motive flow by means of porting water under pressure into the combustion chamber via a high-flow fluid delivery system, thereby lowering the temperature of the body of steam for motive flow to pre-determined optimum turbine-inlet parameters, and adding substantively to the motive flow body of steam in a volume proportional to the volume of water injectate; and,
further including dynamic regulation of temperature of motive fluid steam using temperature feedback data supplied by a sensor or sensors located in immediate proximity to the turbine steam inlet connection, transmitting said feedback data to a manual, analog or digital automatic regulatory mechanism linked to water volume and gas feed-stock flow control valves and associated regulatory subsystem mechanisms; and,
further including dynamic regulation of pressure of motive fluid steam using pressure feedback data supplied by a sensor or sensors located in immediate proximity to the turbine steam inlet connection, and transmitting said feedback data to a manual, analog or digital automatic regulatory mechanism linked to hydrogen and oxygen gas fuel stock volume control valves and associated regulatory subsystem mechanisms; and
further including a central regulatory control system into which is integrated each of the hydrogen, oxygen, and water component subsystems, featuring a multitude of available servo-driven automatic throttling globe valves in direct communication with the controlling software package to regulate in minute detail exact flow characteristics for each of the three pressurized components to the system: molecular hydrogen, molecular oxygen, and water.

2. The system according to claim 1, wherein water supply to the system is supplied from a feed water storage tank containing de-mineralized water, fed through a water deaerator of conventional design to further remove corrosive impurities, and via a boiler feed pump subsystem of conventional design, configured to achieve water pressure sufficient to overcome the maximum steam pressure inside the combustion chamber, that pressure being equal to the pressure considered optimum inlet pressure for a given specific turbine application, and to achieve water supply volume sufficient to supply the requirements of a given specific application, thereby supplying feed water to a feed water distribution subsystem that ports water to high-flow fog head nozzles located inside the combustion chamber; and,
further including computer software-controlled system automation in which system flow-control is regulated when feedback data triggers continuous responses, the software specifically exerting control over a series of servo-actuated automatic valves, and thereby regulating rapid, minute, very accurate adjustments to the water-flow components of the water-supply subsystem; and,
further including a closed-system steam exhaust condensation system of conventional design, in which steam condensate is returned to the holding tank via a condensate extraction pump; and,
further including the addition of water generated by the combustion of fuel stock gases into the holding tank via the condensate extraction pump, thereby available for regeneration into hydrogen and oxygen fuel stocks by an electrolytic generation facility operated in tandem with the steam-generation system, in which surplus generation of the host facility generates gas feed-stocks from raw renewable energy provided by the host system, to be used to co-generate on behalf of the host system.

3. The System according to claim 1, wherein a hydrogen fuel stock supply is regulated in its flow to the system to appropriate feed-pressure and volume parameters, using a hydrogen gas feed pump of sufficient pressure and volume ratings to provide hydrogen fuel stock to the hydrogen supply subsystem at a pressure sufficient to overcome the maximum steam pressure inside the combustion chamber, that pressure being equal to the pressure considered optimum inlet pressure for a given specific application; and,
wherein hydrogen gas fuel stock may be supplied from a system of pressurized gas storage, or from a system of liquefied or slush-consistency cryogenic storage; and,
wherein an oxygen fuel stock supply is regulated in its flow to the system to appropriate feed-pressure and volume parameters, using an oxygen gas feed pump of sufficient pressure and volume ratings to provide oxygen fuel stock to the oxygen supply subsystem at a pressure sufficient to overcome the maximum steam pressure inside the combustion chamber, that pressure being equal to the pressure considered optimum inlet pressure for a given specific application; and,
wherein oxygen gas fuel stock may be supplied from a system of pressurized gas storage, or from a system of liquefied cryogenic storage; and,
further including dynamic regulation of hydrogen and oxygen gas flow volumes and pressures within the gas supply subsystems of each, using pressure feedback data supplied by one or a plurality of transducer sensor or sensors, and using temperature feedback data supplied by one or a plurality of thermocouple sensor or sensors, both located in immediate proximity to the steam inlet connection of its corresponding application; and,
further including computer software-controlled system automation in which system flow-control is regulated when feedback data triggers continuous responses, the software specifically exerting control over a series of servo-actuated globe valves, and thereby regulating rapid, minute, very accurate adjustments to the gas-flow components of the feed-stock supply-subsystems of each.

4. The system according to claim 1, wherein cryogenic liquid or slush hydrogen fuel stock is supplied to the hydrogen fuel stock supply subsystem after passing through pre-heating jacket surrounding the combustion chamber, thereby pressurizing the system by boiling the cryogenic hydrogen using the heat of the combustion chamber.

5. The system according to claim 1, wherein the steam-generating engine is in motive flow communication with a steam-driven turbine that is operatively associated with a generator for the purpose of producing electric power output.

6. The system according to claim 1, wherein the steam-generating engine is in motive flow communication with a steam-driven turbine that is operatively associated with a mechanical system requiring a rotating flywheel, rotor or drive-shaft to produce motive or non-motive force and/or power.

7. The system according to claim 1, wherein the steam-generating engine is in motive flow communication with a steam-driven turbine that is operatively associated with a mechanical system requiring a rotating turbine to produce Newtonian reactive and/or turbojet propulsion, thereby producing motive force.

8. The system according to claim 1, wherein the steam-generating engine is in motive flow communication with a mechanical engine requiring steam to operate a piston to drive its operation.

9. The system according to claim 1, wherein the steam-generating engine is in motive flow communication with a mobile electricity-generating system for the purpose of driving a railroad locomotive engine.

10. The system according to claim 1, wherein a steam-driven power generating system featuring a single steam-generating engine that is in motive-flow communication with the main steam-inlet of a steam-driven turbine that is operatively associated with a generator for the purpose of producing electric power; and,
wherein the exhaust steam exiting the turbine is ported to a condenser unit, within which the water substrate of said exhaust steam is recovered and ported to the holding reservoir tank for further disposition.

11. The system according to claim 1, wherein a steam-driven power generating system featuring two steam-generating engines that are in motive-flow communication with the main steam-inlet, and the intermediate steam-inlet of a steam-driven turbine that is operatively associated with a generator for the purpose of producing electric power; and,
wherein the first steam-generating engine is in motive flow communication with the main or primary stage or high-pressure steam inlet of the turbine, said turbine being operatively associated with the generator; and,
wherein the exhaust steam from the primary stage of the turbine is ported to an intermediate compressor in which the steam pressure is increased to the operating pressure required at the steam-inlet port of the secondary stage of the turbine; and,
wherein the partially reconditioned compressed steam is then ported into the rear of the combustion chamber of the second steam-generating engine as motive fluid substrate into which the system according to claim 1 generates supplemental additive volume to the body of motive flow; and,
wherein the second steam-generating engine is in motive flow communication with the secondary stage or low-pressure steam inlet connection of the turbine; and,
wherein the exhaust steam exiting the secondary or low-pressure turbine exhaust port is ported to a condenser unit, within which the water substrate of said exhaust steam is recovered and ported to the holding reservoir tank for further disposition.

12. The system according to claim 1, wherein a steam-driven power generating system featuring three steam-generating engines that are in motive-flow communication with the main steam-inlet, an intermediate steam-inlet, and the low-pressure steam-inlet of a steam-driven turbine that is operatively associated with a generator for the purpose of producing electric power; and,
wherein the first steam-generating engine is in motive flow communication with the main or primary stage or high-pressure steam turbine inlet of the turbine, said turbine being operatively associated with the generator; and,
wherein the exhaust steam from the primary stage of the turbine is ported to an intermediate compressor in which the steam pressure is increased to the operating pressure required at the steam-inlet port of the secondary stage of the turbine; and,
wherein the partially reconditioned compressed steam is then ported into the rear of the combustion chamber of the second steam-generating engine as motive fluid substrate into which the system according to claim 1 generates supplemental additive volume to the body of motive flow; and,
wherein the second steam-generating engine is in motive flow communication with the secondary stage or reduced-pressure steam inlet connection of the turbine; and,
wherein the exhaust steam from the secondary or reduced-pressure stage of the turbine is ported to a second, lower-pressure intermediate compressor in which the steam pressure is increased to the operating pressure required at the steam-inlet port of the third or low-pressure stage of the turbine; and,
wherein the partially reconditioned compressed steam is then ported into the rear of the combustion chamber of the third steam-generating engine as motive fluid substrate into which the system according to claim 1 generates supplemental additive volume to the body of motive flow; and,
wherein the third steam-generating engine is in motive flow communication with the third stage or low-pressure steam inlet connection of the turbine; and,
wherein the exhaust steam exiting the third stage or low-pressure turbine exhaust port is ported to a condenser unit, within which the water substrate of said exhaust steam is recovered and ported to the holding reservoir tank for further disposition.

13. A proprietary system for the co-generation of solar- and/or wind-generated renewable electric energy production, wherein a steam-driven electric power generating system as described elsewhere herein is deployed to balance the intermittent raw energy output of a solar- or wind-generated renewable electric energy production facility, as that raw energy output is received by a collecting substation; and,
wherein each such facility will produce a median yearly average energy output based on the renewable resources available for conversion into electric energy, such that the total yearly energy output of the facility will equal one-year of continuous, constant output at the median load level; and,
wherein power transmission of the median load level in order to deliver that median load level to a receiving utility customer on a continuous basis, regardless of raw power output produced by the facility; and,
wherein raw power produced in excess of the transmitted median load will be converted into hydrogen and oxygen fuel stocks for storage, to be used at a later date for the generation of electric power through the combustion of those stored fuel stocks using the steam generating engine technology described elsewhere herein; and,
wherein during periods of raw power production below the level of the median, said stored fuel stocks will be utilized as described elsewhere herein to drive a steam turbine-driven generator to produce electric energy equal to the production deficit below said median load level realized at any given moment, thereby allowing the transmission of the median load level to be delivered to said utility customer; and,
wherein said utility customer will thus receive a conditioned, level load of electric energy equal to the median average yearly output of the facility, and derived 100% from the raw output of the renewable energy generating facility.
